(19) United States
(12) Patent Application Publication
(10) Pub. No.: US 2014/0353289 A1
(43) Pub. Date: Dec. 4, 2014

(54) METHOD FOR CLOSING AN APERTURE ON A BLADE OF A GAS TURBINE

(71) Applicant: ALSTOM Technology Ltd, Baden (CH)

(72) Inventors: Ivan LUKETIC, Untersiggenthal (CH); Marcel KOENIG, Wettingen (CH); Laura BOGDANIC, Wettingen (CH)

(21) Appl. No.: 14/280,786

(22) Filed: May 19, 2014

(30) Foreign Application Priority Data
May 29, 2013 (EP) 13169650.2

(51) Int. Cl. B23K 9/00; B23K 9/235; B23K 9/167

(52) U.S. Cl. CPC B23K 9/0026; B23K 9/167; B23K 9/235
USPC 219/75

(57) ABSTRACT

The invention relates to a method for closing an aperture on a blade of a gas turbine, wherein the blade of the gas turbine comprises a tip end with a top surface and a bottom surface. The aperture is formed on the tip end of the blade, and the aperture includes a peripheral edge. The method includes closing the aperture with a weld formed by means of a Tungsten Inert Gas(TIG) welding process without an insert placed in the aperture. With the technical solution of the present invention, it provides a simple and cost effective solution to close the aperture on the tip end of the blade, dispensing with the conventionally utilized “letter-box”, insert, tip cap and the like. In view of this, process of closing the aperture may be simplified, and the cost incurred may be reduced. Further, premature failure of the blade is prevented.

### CROSS-REFERENCE TO RELATED APPLICATIONS

This application claims priority to European application 13169650.2 filed May 29, 2013, the contents of which are hereby incorporated in its entirety.

### TECHNICAL FIELD

The present invention relates to a gas turbine, in particular, to a blade of a gas turbine, more particularly, to a method for closing an aperture on a blade of a gas turbine.

### BACKGROUND

A blade of a gas turbine comprises a root, a platform and an airfoil. Generally, the blade of the gas turbine is operated at high speed and temperature. Thus, it is preferable to form the blade with relative thin, convex and concave side walls with multiple of internal cooling passages for cooling the side walls of the blade. As to improve the cooling efficiency, the internal cooling passage is designed complicated in structures.

Considering the critical aerodynamic shape of the blade and the complicated internal cooling passages, a casting process is usually adopted to manufacture the blade, in which a ceramic or glass core is placed in the mold to form the internal cooling passages. As a result, one or more apertures are left as the casting process is finished since the core has to extend from the tip end of the blade for handling and position. Then, it is necessary to seal the aperture on the tip end of the blade in order to prevent leakage of cooling fluid during operation of the blade. Conventionally, the aperture is sealed by means of a brazed plate, so-called “letter-box”.

A method for plugging a hole on a tip of a gas turbine blade is disclosed in U.S. Pat. No 6,984,801, which comprises steps of fitting a tip plug in a hole formed on a tip of the turbine blade, to provide a butting section between the tip plug and the tip of the turbine blade; performing a butt-weld at the butting section between the tip plug and the tip of the turbine blade by using a laser beam; and plugging the hole.

A turbine blade closure system is disclosed in US20040060964A1, which comprises a closure member capable of being friction welded in an aperture in a hollow-cast turbine blade to prevent the escape of cooling fluids from an internal cavity in the turbine blade. Different shapes of closure members and corresponding treatment to the aperture is also disclosed in this documents.

A method of manufacturing a turbine blade is disclosed in US20070258825A1, which comprises (a) supporting a turbine blade internal core support at opposite ends such that radially inner and outer ends of the turbine blade remain open during casting; (b) casting the blade including the airfoil portion, wherein the radially outer edge of the airfoil portion is inclined relative to horizontal; (c) machining the radially outer edge of the airfoil portion to form a peripheral shoulder about a radially outer opening in the airfoil portion; and (d) seating a tip cap on the peripheral shoulder and fixing, such as welding the tip cap to the airfoil portion of the blade.

It can be seen from above mentioned reference that the tip cap or similar member is adopted in all of their solutions in closing the aperture on the tip end of the blade left from casting process. Tip caps may complicate the overall process of sealing the aperture on the tip end of the blade, so as to make the process cycle prolonged. It is also known that the tip cap so welded on the tip end of the blade may lead to pre-mature failure during operation of the gas turbine, which may result long down time for maintenance and repairing, hence substantial cost incurred.

### SUMMARY

It is an object of the present invention to provide a method for closing an aperture on the tip end of the blade, which may eliminate or at least alleviate the problems mentioned above.

This object is obtained by a method for closing an aperture on a blade of a gas turbine, wherein the blade of the gas turbine comprises a tip end with a top surface and a bottom surface, the aperture is formed on the tip end of the blade, and the aperture comprise a peripheral edge, the method comprise a step of: closing the aperture with a weld formed by means of a Tungsten Inert Gas(TIG) welding process without an insert placed in the aperture.

According to one possible embodiment of the present invention, the TIG process is carried out along the peripheral edge of the aperture.

According to one possible embodiment of the present invention, the TIG process is carried out through an overlaying welding.

According to one possible embodiment of the present invention, the weld formed by the TIG process is extended over the top surface and the bottom surface of the tip end of the blade, respectively.

According to one possible embodiment of the present invention, the method further comprises, before the step of closing, a step of: cleaning the peripheral edge of the aperture and a portion proximate the peripheral edge of the aperture that is affected by the TIG process.

According to one possible embodiment of the present invention, the method further comprises, before the step of closing, a step of: beveling the peripheral edge of the aperture so as to make the same form a predetermined angle relative to the bottom surface of the tip end of the blade.

According to one possible embodiment of the present invention, the method further comprises, after the step of closing, a step of: finishing the weld formed by the TIG process so as to make a top surface of the weld conform with the top surface of the tip end of the blade.

According to one possible embodiment of the present invention, the method further comprises, before the step of closing, a step of: heat treating the tip end of the blade.

With the technical solution of the present invention, it provides a simple and cost effective solution to close the aperture on the tip end of the blade, dispensing with the conventionally utilized “letter-box”, insert, tip cap and the like. In view of this, process of closing the aperture may be simplified, and the cost incurred may be reduced. Further, premature failure of the blade is prevented.

### BRIEF DESCRIPTION OF THE DRAWINGS

The objects, advantages and other features of the present invention will become more apparent upon reading of the following non-restrictive description of preferred embodiments thereof, given for the purpose of exemplification only, with reference to the accompany drawing, through which similar reference numerals may be used to refer to similar elements, and in which:

FIG. 1 shows a schematic plan view of a tip end of a blade of a gas turbine;

FIG. 2 shows a cross-section side view of the tip end of the blade before welding; and

FIG. 3 shows a cross-section side view of the tip end of the blade after welding.

### DETAILED DESCRIPTION

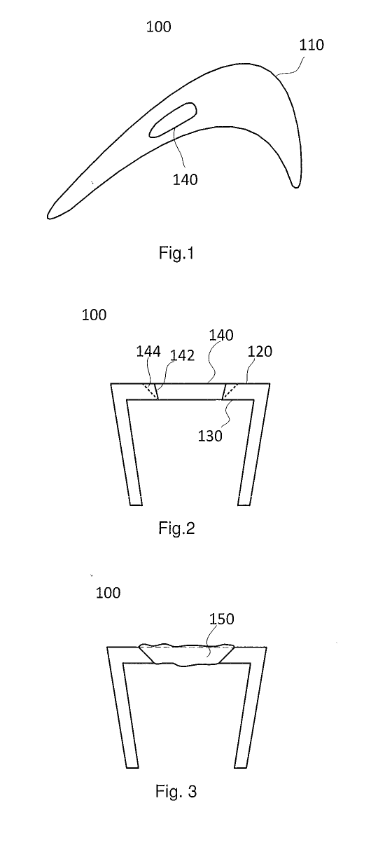

FIG. 1 shows a schematic plain view of a tip end of a blade 100 of a gas turbine. The blade 100 of the gas turbine comprises a tip end 110 with a top surface 120 and a bottom surface 130, shown in FIG. 2. An aperture 140 is formed, such as by casting process, on the tip end 110 of the blade 100, and the aperture 140 comprises a peripheral edge 142, shown in FIG. 2. According to one embodiments of the present invention, a method of closing the aperture comprise a step of: closing the aperture 140 with a weld 150 (shown in FIG. 3) formed by means of a Tungsten Inert Gas(TIG) welding process without an insert placed in the aperture 140.

In one possible embodiment of the present invention, the TIG process is carried out along the peripheral edge 142 of the aperture 140. In particular, the TIG process begins from the peripheral edge 142 of the aperture 140, and proceeds in a spiral manner toward the centre of the aperture 140, where the TIG process is finished and the aperture 140 is closed by the weld 150.

In one preferred embodiment of the present invention, the blade 100, in particular, the tip end 110 thereof, may subject to heat treatment before welding to make the tip end 110 of the blade 100 more weldable and to avoid cracks in the resultant weld 150. Thus, the method may comprise a step of: heat treating the tip end 110 of the blade 100.

It should be understand by those skilled in the art that, as the thickness, i.e. the distance between the top surface 120 and the bottom surface 130, of the tip end 110 of the blade 100 is much large in some blade, the weld 150 can not fill out the whole thickness of the tip end 110. In this case, the TIG process may be carried out through an overlaying welding according to one preferable embodiment of the present invention, in order to sufficiently fill out the thickness of the tip end 110 hence assure the enough strength of the weld 150.

In actual applications, the tope surface 120 and the bottom surface 130 may not remain flat due to processing varieties and fabricating errors. In this case, as shown in FIG. 3, the weld 150 formed by TIG process may be extended over the top surface 120 and the bottom surface 130 of the tip end 110 of the blade 100, respectively, in order to eliminate any unevenness in the top surface 120 and the bottom surface 130, hence to assure the strength and appearance of the weld 150 and the top surface 120, even though the appearance of the bottom surface 120 represents less importance.

According to one preferred embodiment of the present invention, the method further comprises a step of cleaning the peripheral edge 142 of the aperture 140 and a portion proximate the peripheral edge 142 of the aperture 140 that is affected by the TIG process, before the step of closing. The step of cleaning may be utilized to remove any oxidized metal covering the peripheral edge 142 of the aperture 140 and the portion proximate the peripheral edge 142 of the aperture 140 that is affected by the TIG process, which may prevent the oxidized metal deteriorate the quality of the weld 150.

Additionally, in one possible embodiment of the present invention, as shown by the break lines in FIG. 2, the peripheral edge 142 of the aperture 140 may be beveled. Thus, the method according to the present invention my further comprises a step of beveling the peripheral edge 142 of the aperture 140 so as to make the same form a predetermined angle relative to the bottom surface 130 of the tip end 110 of the blade 100, before the closing step. The bevel 144 thus formed may facilitate the welding process and weld strength. As to the angle between the bevel 144 and the bottom surface 130, those skilled in the art may select suitable angle, such as, 30°, 45°, and the like, according to particular applications.

Additionally, the method according to one embodiment of the present invention may further comprise a step of finishing the weld 150 formed by the TIG process so as to make a top surface of the weld 150 conform with the top surface 120 of the tip end 110 of the blade 100. This finishing step may be carried out by means of machine tools, or may be manually performed. The finished top surface of the weld generally flush with the top surface 120 of the tip end 110 of the blade 100 in order to provide a smooth and finished surface for further processing and assembly.

It should be understood by those skilled in the art that the above described steps and performing sequence thereof may be selected and determined according to particular applications. It is intended that any combination of the above described steps fall into the protection scope of the present invention, provided that the said combination constitute one possible solution in addressing certain technical problems encountered during field practice.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A method for closing an aperture on a blade of a gas turbine, wherein the blade of the gas turbine includes a tip end with a top surface and a bottom surface, the aperture is formed on the tip end of the blade, and the aperture comprise a peripheral edge, the method comprising:
closing the aperture with a weld formed by means of a Tungsten Inert Gas(TIG) welding process without an insert placed in the aperture.

2. The method according to claim 1, wherein, the TIG process is carried out along the peripheral edge of the aperture.

3. The method according to claim 1, wherein, the TIG process is carried out through an overlaying welding.

4. The method according to claim 1, wherein, the weld formed by the TIG process is extended over the top surface and the bottom surface of the tip end of the blade, respectively.

5. The method according to claim 1, further comprising, before the step of closing :
cleaning the peripheral edge of the aperture and a portion proximate the peripheral edge of the aperture that is affected by the TIG process.

6. The method according to claim 1, further comprising, before the step of closing:
beveling the peripheral edge of the aperture so as to make the same form a predetermined angle relative to the bottom surface of the tip end of the blade.

7. The method according to claim 1, further comprising, after the step of closing :
finishing the weld formed by the TIG process so as to make a top surface of the weld conform with the top surface of the tip end of the blade.

8. The method according to claim 1, further comprising, before the step of closing:
heat treating the tip end of the blade.
